(19) United States
(12) Patent Application Publication
(10) Pub. No.: US 2018/0120914 A1
(43) Pub. Date: May 3, 2018

(54) UNIFIED POWER DEVICE MANAGEMENT AND ANALYZER

(71) Applicant: SILICON GRAPHICS INTERNATIONAL CORP., Milpitas, CA (US)

(72) Inventor: Patrick J. Donlin, Deephaven, MN (US)

(21) Appl. No.: 15/336,506

(22) Filed: Oct. 27, 2016

(51) Int. Cl. G06F 1/28

(52) U.S. Cl. CPC G06F 1/28

(57) ABSTRACT

The present disclosure is directed to monitoring power devices in a data center. The present disclosure describes systems, methods, and non-transitory computer readable storage mediums that provide increasing amounts of power monitoring and ultimately comprehensive power monitoring, power control, power failure forecasting, power event alerts, power data collection, and that manages power corrective actions. Systems, methods, and non-transitory computer readable storage mediums of the present disclosure may also gather intelligence by analyzing data trends over time such that design weaknesses can be identified an addressed in next generation data center computing and power distribution system designs.

### BACKGROUND OF THE INVENTION

### Field of the Invention

The present disclosure is generally related to monitoring power. More specifically the present disclosure is related to monitoring power at various levels in a computer system.

### Description of the Related Art

Today a single modern data center consumes as much or more power than a moderately sized city. Power consumed by a single data center can top 1 million Watts, more than a Mega-Watt (MW) wherein individual servers in such a data center may consume hundreds or thousands of Watts. Such systems include thousands of electrical circuits that provide electrical power to different sorts of equipment within a data center. The different systems and sub-systems included in the modern data center have different power input requirements. For example, a server may require 110V alternating current (AC) power be provided to it, disk drives in or associated with such a server may require 5V direct current (DC) power, and logic included in such a server may run on 3.3 V DC power. Furthermore, AC main power inputs (AC mains) may provide 3-phase AC power, 2-phase AC power, and 1-phase AC power where each type may have different power requirements. For example, data centers could be provided AC power as: 3 power lines with 480V phase to phase, 2 power lines that provide 208 V phase to phase power lines (phase to phase, 2-phase AC power), and 110V phase to ground (common/neutral) AC power lines.

As soon as AC mains enter a data center, they may be connected to one or more types of computing equipment, computer servers, for example. Each different piece of computing equipment requires several or even dozens of different power supplies. In an example, a single server may include a dozen trays of equipment or include a dozen server blades, and each of these tray or blades may include one or more DC power supplies or regulators. Such a server could easily include at least 12 DC power supplies or power regulators. Every day data centers are being expanded, commonly these data centers include hundreds or thousands of servers. Because of this, as the number of compute servers in a data center is increased linearly, the number of power supplies/regulators increase geometrically. This means that the likelihood of power supply failure is increasing geometrically as the number of servers in a data center increases linearly.

Because of concerns regarding power supply failure, computer companies are beginning to embrace standards like the power management BUS (PMBUS) standard. The PMBUS standard allows power equipment to provide status and other data to external computing devices. While PMBUS is a necessary step forward in monitoring power systems in a data center, PMBUS does not provide comprehensive power monitoring, power control, power failure forecasting, power event alerts, power data collection, and does not manage corrective actions when failures occur. As such, PUBUS is not a system that protects the data center by monitoring and analyzing the performance of power systems in the data center. Furthermore, PMBUS does not provide the intelligence required to identify weaknesses in the design of power systems in data centers over time.

What are needed are systems and methods that provide increasing amounts of power monitoring and ultimately comprehensive power monitoring, power control, power failure forecasting, power event alerts, power data collection, and that manages power corrective actions. What also are needed are systems and methods that gather intelligence by analyzing data trends over time such that design weaknesses can be identified an addressed in next generation data center computing and power distribution system designs.

### SUMMARY OF THE PRESENTLY CLAIMED INVENTION

The presently claimed invention includes systems, methods, and non-transitory computer readable storage mediums for monitoring devices in a data center. A system consistent with the presently claimed invention may include a plurality of power devices and a plurality of computing devices in a data center. A monitoring device in the data center may receive information from the plurality of power devices that is stored in a database. The monitoring device may collect information from each of the power devices incrementally over time. Each of the information collected over time may also be stored in the database. Status information relating to how the power devices are operating may be identified, when a status associated with a power device is identified as being a bad (not good) status. When a bad status is identified, a message may be sent identifying that the status of the power device is bad. The message may initiate an action directed at correcting or addressing the bad status of the power device. Methods of correcting or addressing discrepant power device status include, yet are not limited to replacing a power device, reducing a workload associated with a resource attached to the power device, or performing a controlled shutdown of the power device or resources attached to the power device.

Methods consistent with the presently claimed invention may also include a monitoring device in the data center that receives information from a plurality of power devices, where that information is stored in a database. The monitoring device may also collect information from each of the power devices incrementally over time by polling each of the power devices. The information collected over time may also be stored in the database. Status information relating to how the power devices are operating may be identified, when a status associated with a power device is identified as being a bad (not good) status, a message may be sent identifying that the status of the power device is bad. The message may initiate an action directed at correcting or addressing the bad status of the power device.

A non-transitory computer readable storage medium of the presently claimed invention may include a monitoring device in the data center that receives information from a plurality of power devices, where that information is stored in a database. The monitoring device may also collect information from each of the power devices incrementally over time by polling each of the power devices. The information collected over time may also be stored in the database. Status information relating to how the power devices are operating may be identified, when a status associated with a power device is identified as being a bad (not good) status, a message may be sent identifying that the status of the power device is bad. The message may initiate an action directed at correcting the bad status of the power device. As mentioned above actions directed at correcting or addressing power device related issues in the data center may include: replacing a power device, reducing a workload associated with a resource attached to the power device, or performing a controlled shutdown of the power device or resources attached to the power device.

### BRIEF DESCRIPTION OF THE DRAWINGS

FIG. 1 illustrates an exemplary an drawing of alternating current (AC) power management controller monitoring AC input power to a data center

FIG. 2 illustrates an exemplary direct current (DC) power supply that is powered by an alternating current (AC) power source.

FIG. 3 illustrates an exemplary voltage regulator power supply unit that may be used in embodiments of the present disclosure.

FIG. 4 illustrates an exemplary set of power supply units that communicate with a management controller.

FIG. 5 illustrates two different examples of server compute array/power supply topologies that can be used with systems and methods consistent with the present disclosure.

FIG. 6 illustrates an exemplary system where two different processor modules receive power from voltage regulators.

FIG. 7 illustrates an exemplary instance of monitoring of the health of the data center by a power health manager monitoring and organization system.

FIG. 8 illustrates an exemplary process flow example that may be implemented by a monitoring agent.

FIG. 9 is a block diagram of an exemplary system for implementing a computing device.

### DETAILED DESCRIPTION

The present disclosure is directed to systems and methods that provide increasing amounts power monitoring of and ultimately comprehensive power monitoring, power control, power failure forecasting, power event alerts, and power data collection. The present disclosure is also directed to managing corrective actions, to identifying risk factors, and to monitoring environmental factors that may be associated with failures in the data center. Systems and methods that gather intelligence by analyzing data trends over time such that design weaknesses in current generations of data center systems may be identified and be addressed by improved designs of next generation data center computing and power distribution systems is an important long term goal of the present disclosure.

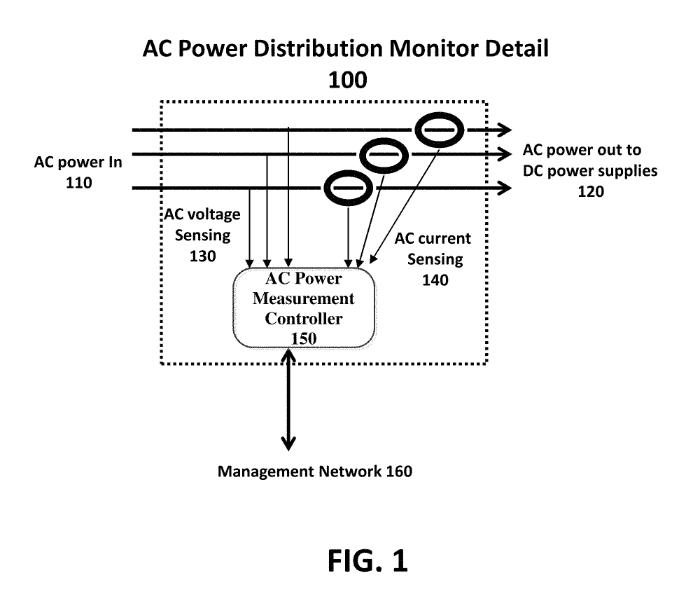

FIG. 1 illustrates an exemplary an drawing of alternating current (AC) power management controller monitoring AC input power to a data center. FIG. 1 illustrates details of exemplary AC power distribution monitor 100. FIG. 1 includes AC power in 110, AC power out to DC power supplies 120, and an AC power management controller 150. FIG. 1 illustrates AC voltage sensing inputs 130 and AC current sensing inputs 140 that connect to the AC power measurement controller 150. The 3 AC power inputs 110 depicted in FIG. 1 may correspond to three phase AC power being provided to a system consistent with the present disclosure. Alternatively AC power inputs 110 may connect to two phase or one phase AC power lines. AC power measurement controller 150 may be a stand-alone device or may be included in a power supply or in a power switch. AC power measurement controller 150 may also communicate over monitoring network 160 when providing information to other systems or components consistent with the present disclosure.

When AC power 110 inputs are 3 phase power inputs, power flowing through these AC power 110 inputs may be monitored with the intent of dynamically balancing power the power provided by each phase of the 3 phases power inputs. As such, power management controller 110 may be used to monitor power distribution whey dynamically balancing power provided to the data centers. When power distribution is perfectly balanced, each phase of the three phase power provided to the data center will provide an identical amount of power. In an instance where power supplied to different phases is out of balance, the power distributed to particular parts of a system consistent with the present disclosure may be switched from one phase to another. As such, one or more servers may be switched from one phase to another phase when adjusting an amount of power provided by one phase versus another phase.

Systems consistent with the present disclosure may dynamically adapt power loads per phase such that power consumption per phase is sufficiently or optimally balanced. Measures of sufficiently balanced per phase power may correspond to measures of relative power or to measures of total power. Measures of relative power include a measure of power provided to a first phase relative to a second and/or a third phase, for example. Measures of total power include comparing a total amount of power consumed by a plurality of phases to a measure of power consumed by one or more specific input phases.

In a first example, when one phase currently provides 500 Kilo-Watts (KW) of power while a second phase delivers 450 KW, the relative power that the second power phase provides relative to the first power phase is 90%, as calculated by the equation: P2/P1×100=450 KW/500 KW×100. This amounts to a 10% “relative phase 1 to phase 2 percentage power difference of 10%. In such an instance data center policies may identify conditions when the amount of power consumed by phase 1 and phase 2 should be adjusted. When a policy indicates that the phase 1 to phase 2 relative power percentage difference should not exceed 5% difference, a group of servers could be switched from phase 1 to phase 2.

In an instance where a group of servers connected to one or more AC switches consumes 20 KW, that group of servers may be switched from phase 1 to phase 2. After such a switching event, phase 1 would consume 480 KW and phase 2 would consume 470 KW, yielding a 2% relative phase 1 to phase 2 relative power percentage difference as phase 2 provides about 98% (i.e. 470 KW/480 KW×100) as much power as phase 2. In in instance when such a system includes a third power phase (phase 3), a power balancing method consistent with the present disclosure may include an additional step where a power phase that currently provides the most power and a power phase currently provides the least power are identified before loads are adjusted.

Switches use switch servers from one power phase to another may include banks of solid state relays or include other power devices designed for switching power loads electrically could be used. As such, relatively glitch free and spark free AC power switching could be accomplished within one or more 60 Hertz (Hz) power cycles. Such switches could also be used to switch as few as one server from the first phase to a the second phase. These switches could also be configured to switch one server at a time in a sequence that switches an entire group of servers from the first phase to the second phase over many power cycles.

Other methods for remediating imbalanced power phases include routing jobs to servers connected to power phases that are currently consuming a lower amount of power as compared to other phases, and by routing jobs away from power phases that are currently consuming higher amounts of power.

Policies relating to load balancing may also use calculations based on power a total amount of power consumed by a plurality of power phases. Again in the instance where the first and the second phase consume 500 KW and 450 KW respectfully (i.e. a total phase 1+phase 2 power of 950 KW). In this instance, the first phase is currently consuming about 53% (500 KW/950 KW×100) of the total 950 KW of power and the second phase is currently consuming about 47% (450 KW/950 KW×100) of the total 950 KW of power. That's about a 3% difference relative to the total power consumed by the first and second phases. In such an instance, a policy could dictate that power should be re-balanced with there is more than a 2% total power difference phase to phase. As such, thresholds that trigger a re-balancing of power can correspond to a relative measure of power balance or could correspond to a measure of total power.

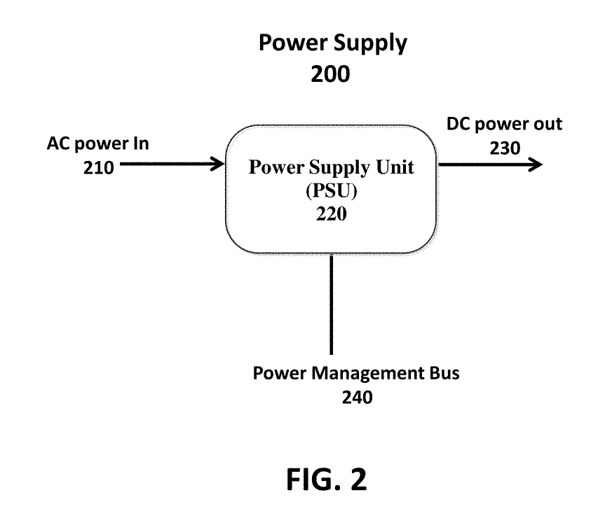

FIG. 2 illustrates an exemplary direct current (DC) power supply that is powered by an AC power source. The power supply 200 of FIG. 2 includes AC power inputs 210, DC power output 230, and an AC to DC power supply unit (PSU) 220. PSU 220 may communicate with a power management controller or sub-controller (not illustrated in FIG. 2) over power management bus 240. PSU 220 converts AC input power 210 to DC output power 230. PSU 220 may be configured to send information over power management bus 240 to a power management controller. Information that may be sent by PSU 220 to a power management controller over power management bus 240 may include a power supply number, a power supply type, a power supply serial number, AC power input, a voltage level of AC power input, a measure/value of AC input current, a measure/value of DC power output, a measure/value of DC voltage output, a measure/value of a measure of power efficiency, a measure/value of DC current output, a temperature, a humidity associated with PSU 220, and other operating characteristics associated with PSU 220.

As such, data sent over power management bus 240 may be used to identify how PSU 220 is operating over time. Trends in power efficiencies and changes in power/voltage/current input or output can be collected over time. This data collected may be evaluated by software that collects information from many different power supply units. After data has been collected over time, the relative performance of different power supply units with similar characteristics may be used to identify specific power supply units that have better or worse performance characteristics. In instances where one or more specific power supply units are associated with poor performance, a corrective action may be ordered. Corrective actions may include, yet are not limited to replacing power units that have poor performance and reducing a load (i.e. an amount of current) that a poor performing power unit delivers.

In certain instances, the power management network interconnect may be monitored by a supervisor or by software that performs the function of supervising or analyzing factors affecting power distribution to systems consistent with the present disclosure. Exemplary AC to DC power supplies may each provide 12 V DC from 480 V 3-phase AC power input lines, where each DC power supply may provide Kilowatts of power.

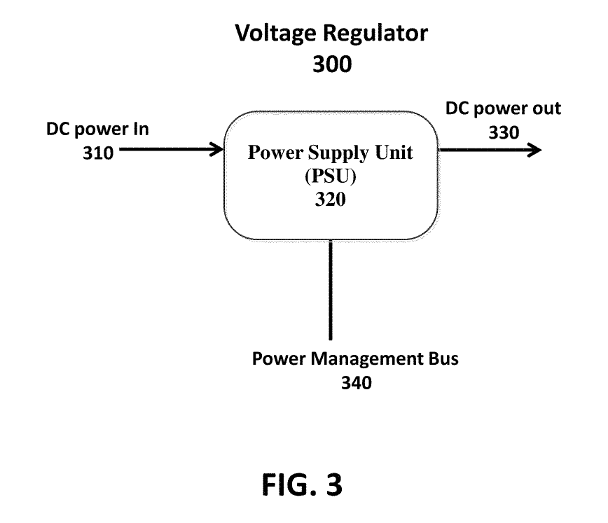

FIG. 3 illustrates an exemplary voltage regulator power supply unit that may be used in embodiments of the present disclosure. FIG. 3 includes power supply unit 320 (regulator), DC power input 310, DC power output 330, and power management bus 340. PSU 220 may communicate with a power management controller or sub-controller (not illustrated in FIG. 2) over power management bus 340. PSU 320 converts DC input power 310 to DC output power 330. PSU 320 may be configured to send information over power management bus 340 to a power management controller. Information that may be sent by PSU 320 to a power management controller over power management bus 340 may include a power supply model number, a power supply type, a power supply serial number, DC power input, a voltage level of DC power input, a measure/value of DC input current, a measure/value of DC power output, a measure/value of DC voltage output, a measure/value of a measure of power efficiency, a measure/value of DC current output, a temperature, a humidity associated with PSU 320, and other operating characteristics associated with PSU 320.

Data sent over power management bus 340 may be used to identify how PSU 320 is operating over time. Trends in power efficiencies and changes in power/voltage/current input or output can be collected over time. This data collected may be evaluated by software that collects information from many different power supply units. After data has been collected over time, the relative performance of different power supply units with similar characteristics may be used to identify specific power supply units that have better or worse performance characteristics. Instances where one or more specific power supply units are associated with poor performance, they may be replaced. In certain instances the power management network interconnect may be monitored by a supervisor or by software that performs the function of supervising or analyzing factors affecting power distribution to systems consistent with the present disclosure. In certain instances the output of a DC to DC power supply may have a lower voltage than a voltage input to the DC to DC power supply. The present disclosure however is not limited to DC to DC power supplies have lower output voltages than input voltages, as some of these power supplies could be switched DC to DC converters. For example, switched DC to DC converters often provide a higher DC output voltage as compared to an input voltage. Such switched DC to DC power converters may convert a DC input voltage to an AC signal that is then converted back into a DC output voltage of virtually any desired value.

One failure that can affect switched DC to DC converters is latch-up. Latch-up may be caused by switching logic inside of the converter going into a meta-stable state. Such meta-stable states can be caused by either by rapidly changing loads or by electromagnetically induced transients (spikes).

An example of a direct transient is the abrupt turning on or off of a load causing a ringing or change in a voltage of a DC to DC converter. Such direct power surge spikes can be caused by powering on/off a bank of disk drives, one or more motors, or other devices. An example of an indirect transient is where electrical noise is inductively coupled to a DC to DC converter via electro-magnetic induction. Such indirect inductively coupled transients (spikes) may be caused by transients associated with the switching of power phases, transients associated with the operation of digital logic, and transients associated with loads/voltages that are not directly coupled to a DC to DC converter. Another source of electrical transients (spikes) are caused by a power saving mode where processors and memory are put into a power saving mode. When not in use for even a small number of milliseconds, the processors and memory may enter a low power ‘sleep’ state where there is almost no electrical activity. As soon as demand arises, the processors begin rapidly executing code out of memory. When this occurs, voltage surge currents may cause the voltage output of a power regulator to overshoot and generate transients as the memory and the processors and memory turn on. These transients may cause processor or memory malfunctions and bit errors.

When a latch-up event occurs, the output of the DC to DC converter may fail temporarily (in a “transient” way). As such, DC to DC converters that do latch-up may recover and operate normally after being power cycled. In such instances, components that may fail temporarily occasionally may indicate that a component is susceptible to failure in an apparently non-repeatable way. Systems and methods consistent with the present disclosure may be used analyze such anomalous failures. For example, an analysis program may compare accumulated failure data with information that identifies possible modes of failure that may be associated with a type of device. As such a database may be used to cross reference accumulated data with device type data and with possible (or theoretical) failure modes when identifying components that may have a weakness in their design. For example, if a particular type of DC to DC converter fails in different machines in a data center once a week, that component may be identified as possibly being associated with one or more specific defect types. In such circumstances, software of the present disclosure may order an engineering response team to investigate a component when improving the design of the component, when eliminating the vendor that made the component from an authorized vendor list, or when improving the design of systems within the data center.

In such an instance collected data may include measurements consistent with a DC to DC converter latch-up. In these instances, a processor executing an analysis program may identify one or more symptoms that correspond to the failure. For example, when failure symptoms include an output voltage is out of range (too high/low), include an output voltage that varies excessively, and include the fact that the DC to DC converter operated normally after a power cycle, the processor may identify that the failure may be associated with a DC to DC converter latch-up event.

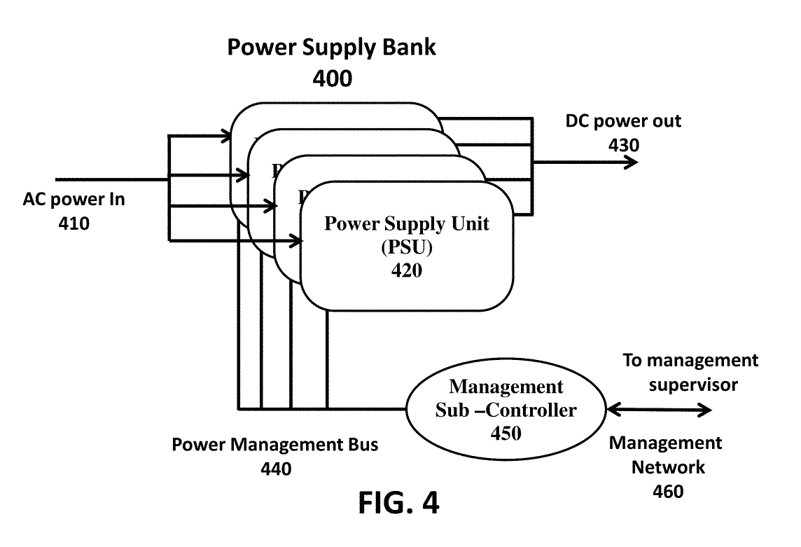

FIG. 4 illustrates an exemplary set of power supply units that communicate with a management controller. FIG. 4 includes four AC to DC power supply units 420, AC power inputs 410, and DC power outputs 430. Each PSU 420 may communicate with management sub-controller 450 over power management bus 440, and management sub-controller 450 may communicate with other devices over management network 460. The other devices that sub-controller 450 communicates with may supervise the operation of each PSU 420 and/or analyze data collected relating to each PSU 420 over time.

Notice that output of the plurality of DC power supplies 420 are connected in parallel. As such, even if one of these power supplies fails, the other DC power supplies may still provide DC power to the system. These modern DC power supplies may be designed to minimize or mitigate current looping.

Power management bus 440 may be a two wire bus, such as a bus consistent with the power management bus (PMBUS) specification. Management sub-controller 450 may communicate with other devices, such as a power management computer or server over a network communication interface (such as Ethernet, InfiniBand, a custom interface, or another standard interface) according to a preferred protocol (such as TCP/IP, HTTP, HTTPS, or other protocol). Power management bus 440 may be an interface that provides information regarding a particular power to management sub-controller 450.

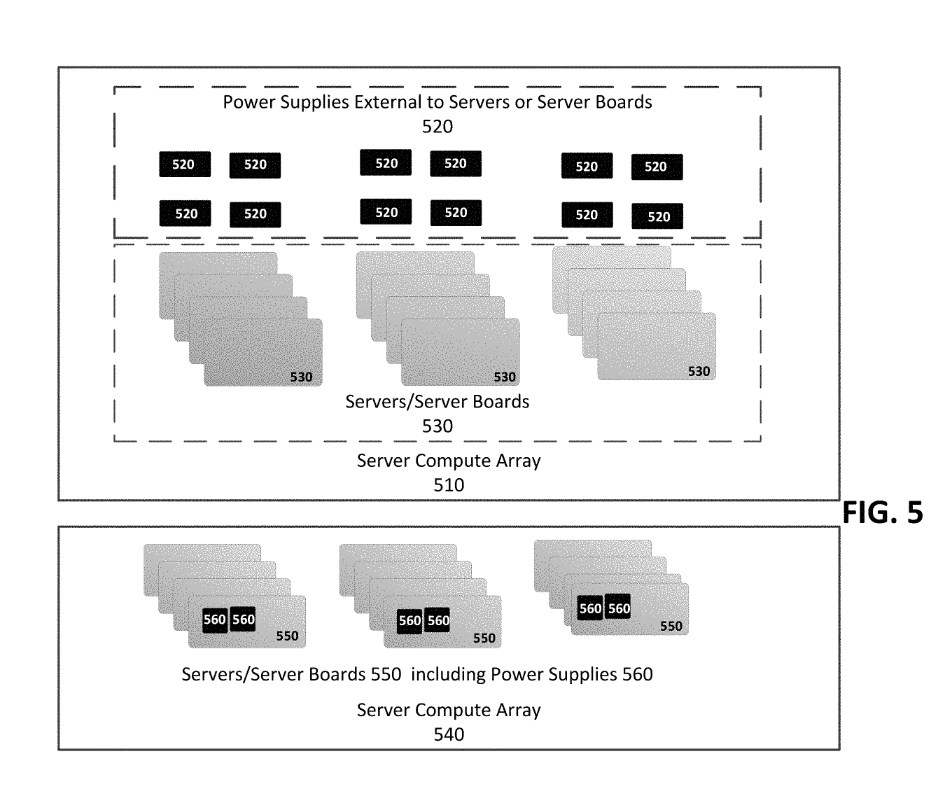

FIG. 5 illustrates two different examples of server compute array/power supply topologies that can be used with systems and methods consistent with the present disclosure. Server compute array 510 includes power supplies 520 that provide power to servers or server boards 530. Here power supplies 520 may be external to servers or server board 530. As such, cables or bus bars may be used to transfer power from power supplies 520 to server/server boards 530. When items 530 of FIG. 5 are servers, power supplies 520 may be power supplies that are adjacent to servers 530. When items 530 of FIG. 5 are server boards, each of these servers may or may not include on board power supplies.

Power supplies 520 of FIG. 5 may also include power management busses as discussed in relation to FIGS. 2-4. In certain instances server/server boards may also report information relating to input power, input voltage, input current, temperature, and humidity. In such instances, server/server boards 530 may report information over a power management bus (such as PMBUS) or they may report information over a computer network interface.

Server/server boards 530 may, for example, report both temperature and humidity to a supervising agent (such as person or software program) and the supervising agent may identify that the temperature and humidity associated with server/server boards 530 is approaching a condition where condensation may begin to form in a server or on a server board 530. As such, a supervising agent may then identify a corrective action that should be taken to prevent condensation from precipitating in a server or on a server board 530. Such an action could include turning on an air conditioner, turning on a dehumidifier, or turning off a server when attempting to prevent a failure.

Similarly, elevated temperatures or rapid temperature changes may be used to identify risk factors associated with failure probabilities of system components. Temperature related risk factors may be associated with measures of thermal stress when temperatures increase above a temperature threshold. Temperature related risk factors may also be associated with thermal shock (rapidly changing temperatures). In instances where data centers are located in locations that experience cold winter temperatures and where external air may be used to cool the data center, temperature related risk factors may include stress due to exposure to cold (below a threshold value) or a rapid change from a cold temperature to a hot temperature.

Another risk factor to the data center is fire, as such, smoke detectors/sensors or carbon dioxide sensors may also be used when monitoring the operating conditions of the data center. In such instances, the each server in a data center could include a smoke detector or carbon dioxide sensors. One type of fire that can occur in a data center is a fire caused by a short circuit. For example, a short circuit forming from a defect in a circuit board, such as a flame retardant-4 (FR4) server backplane can cause the FR4 in the backplane to burn as long as power is provided to the backplane. In such an instance, the fire could spread to other components, devices, enclosures, or cables in the system. This not only generates vast amounts of toxic smoke, it could lead to a catastrophic failure of the entire data center immediately, cause latent failures to occur over time, and could harm people working in the data center.

One way that fire/smoke could cause latent failures is by smoke particles depositing on other devices in the data center. These smoke particles can lead to clogged air cooling filters, clogged filters in disk drives, and ionic contamination of circuit boards. Clogged air cooling filters can result in poor cooling of computer equipment. Clogged filters in disk drives could lead to disk drive failure. Ionic contamination can lead to the formation of new short circuits (via intermetallic growth and/or oxidation) that could cause latent equipment failure that could even cause a second fire.

Because of another reason, the modern data center may be at an elevated risk of electrical short circuits occurring spontaneously today than ever before. This is because of the move to eliminate lead in solder. Solder is a basic substance used to assemble printed circuit board assemblies, it holds the leads of components onto printed circuit board and it makes electrical connections between electrical/electronic components and traces on a circuit board. The use of little to no lead in modern solder has led to these solder's including mostly tin. Solders with high levels of tin and little or no lead are known to form “tin whiskers” over time. These “tin whiskers” literally grow in a manner that appears like a hair has grown over time. “Tin whiskers” are also known to create short circuits when they grow long enough to connect one electrical conductor to another.

Short circuits can be detected by various means including identifying that a current value provided by a power supply exceeds a threshold value. As such, when a power supply provides an excessive amount of current, it could be shut down. In instances where more than one power supply are connected in parallel, multiple power supplies failing at or near the same time could indicate that a short circuit has occurred.

While circuit breakers may also be used in systems of the present disclosure, circuit breakers are a relatively crude measure of indications of over current. In certain instances, intermetallic growth or oxidation may cause impedance between power and ground to reduce over time. In such instances, the present disclosure may identify that a service call should be performed because a power supply is providing excessive (over threshold amount of) current before a failure event has occurred. As such, identifying that one or more power supplies providing excessive current may trigger a maintenance call before a circuit breaker opens or before a fire has a chance to start. Analysis software of the present disclosure may associate a programming task workload associated with server with an amount of power typically consumed by that server when executing the programming task workload. As such, identifying that an amount of power consumed by the server when executing the particular programming task workload has increased over time could trigger a service call. Methods of the present disclosure enable failure analysis of defective components to occur well before a component has failed. In fact, data collected may include virtually the entire life of a particular component. As such, detailed histories may be provided to component manufactures when the component manufactures research the root cause of a failed part.

The second server compute array 540 of FIG. 5 also includes a plurality of power supplies 560 that are installed within servers or on server boards 550. In such instances, server compute array 540 may function similarly to server compute array 530, except that power supplies 560 are located within servers or on server boards 530.

Here again power supplies 560 of FIG. 5 may also include power management busses as discussed in relation to FIGS. 2-4. In certain instances server/server boards may report information relating to input power, input voltage, input current, temperature, and humidity. In such instances, server/server boards 550 may alternatively or additionally report information over a power management bus (such as PMBUS) or they may report information over a computer network interface.

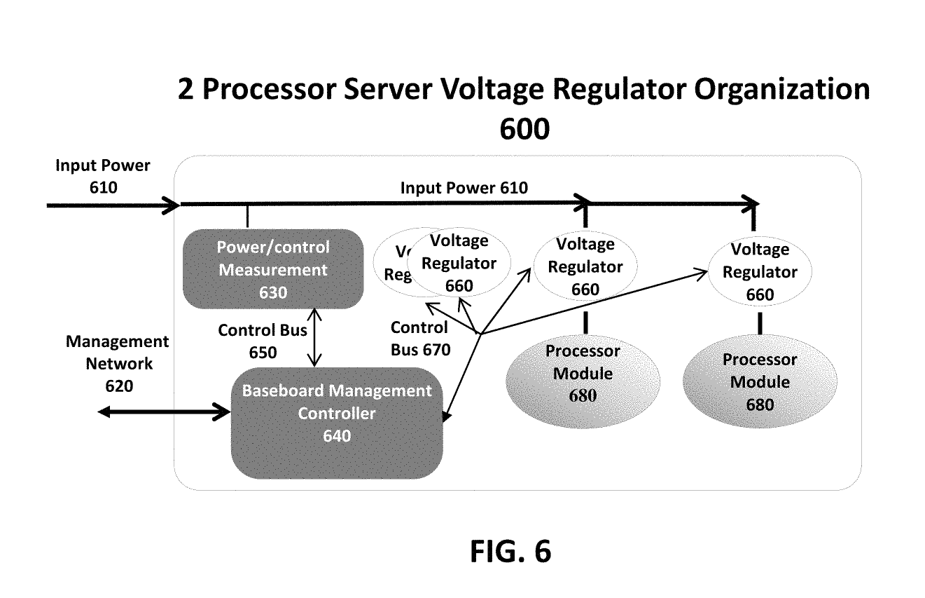

FIG. 6 illustrates an exemplary system where two different processor modules receive power from voltage regulators. FIG. 6 illustrates voltage regulators 660 organized to provide power to 2 different processor modules 680. FIG. 6 also includes input power 610, power/control measurement monitor 630, baseband management controller 640, control bus 650, control bus 670, and management network interface 620. Note that power/control measurement monitor 630 communicates with baseboard management controller 640. Note also that baseboard management controller 640 communicates with voltage regulators 660 over control bus 670. Systems of the present disclosure may include multiple different communication paths. In such instances, measurement monitor 630 or baseboard management controller 640 may include redundant communication busses (not illustrated) such that communication with power supplies or servers/server boards may be maintained even when one communication path fails.

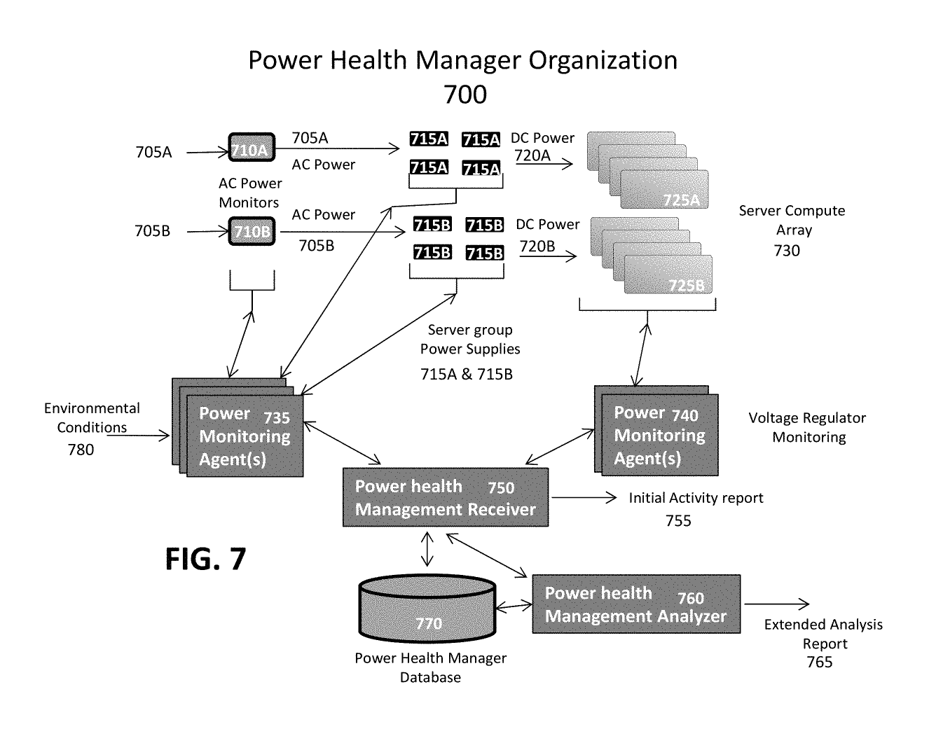

FIG. 7 illustrates an exemplary instance of monitoring of the health of the data center by a power health manager monitoring and organization system. FIG. 7 illustrates power health manager organization system 700 monitoring power. The power health manager organization system 700 of FIG. 7 includes power monitoring agents 735 & 740 communicating with power health management receiver 750. Power monitoring agents 735 receives information from AC power monitors 710A, 710B, and power supplies 715A & 715B, as indicated by the lines with double arrows connecting power health monitoring agents 735 to AC power monitors 710A/710B. Power monitoring agents may also monitor DC power outputs 720A/720B. Information received by power monitoring agents 735 may be passed to power health management receiver 750, where power health management receiver 750 may store data in power health manager database 770. FIG. 7 also includes power health manager organizer 760 communicating with power health management receiver 750 and accessing information stored in the power health manager database 770.

Monitoring agents consistent with the present disclosure may be implemented as discrete devices, be implemented on expansion boards, or be implemented by processors of a server. For example monitoring agents 735 and 740 may communicate with power devices over a power management bus when collecting data from those power devices, after which the collected data may then be passed over a network connection to power health monitoring agent 750. Alternatively or additionally monitoring agents may include or be directly connected to sensors, measurement circuits, or to a measurement devices. In certain instances, monitoring agents may include only digital components that collect information from power devices over a digital bus. Alternatively or additionally monitoring agents may include or be connected to analog components, such as; analog to digital converters, sensors, low impedance sense resistors, inductive current measurement loops, or other analog circuits. Because of this, monitoring agents may be implemented using combinations of processors, memory, field programmable gate arrays (FPGAs), application specific integrated circuits (ASICs), analog circuits, firmware, and/or software. For example, a monitoring agent could be coupled to two sides of a sense resistor that is connected in series with a power supply, where the monitoring agent could measure a voltage drop across the sense resistor when identifying a current being provided by the power supply. Monitoring agents may also include a computer network interface. For example, Ethernet may be used to communicate data from monitoring agent 735 to power health management receiver 750.

Power health management receiver 750 may be implemented in a computer or in a server. Power health management receiver 750 be configured to run application software and may communicate over a computer network with power health management analyzer 760. Similarly, power health management analyzer 760 may also include a computer or a server running software programs tailored to evaluate/analyze collected power device data. The functionality of a power health management receiver 750 and power health management analyzer 760 may be performed by a plurality of computers or they may both be performed by a single computer. Systems consistent with the present disclosure may employ many power health monitoring agents, numerous power health management receiver, and a few (or a single) power health management analyzer. As such, methods of the present disclosure may be spread over multiple tiers that include basic analog measurements by power devices/circuits/monitoring agents, the basic collection of raw data associated with particular devices by power monitoring agents, the con-catenation of raw data from multiply power monitoring agents by power management health receivers, and the evaluation/analysis of the collected data by a power health management analyzer.

Data stored in database 770 may be evaluated by power health management receiver 770 or by power health manager organizer 760 when identifying failure trends. Such trends may be related to certain devices experiencing a “hard” failure or be related to devices experiencing a temporary or “transient” failure. Hard failures may be a failure that causes a component or device to permanently stop working within expected operational parameters.

Temporary or “transient” failures may occur for apparently no reason. For example, the transient (spike) induced “transient” (temporary) latch-up failure discussed earlier in this disclosure may appear to have an unknown cause. An analysis program executed by a processor of the power health manager organizer 760, for example, could identify that a DC to DC converter in the data center is associated with a number of temporary failures over time. A processor executing such an analysis program may identify that these DC to DC converters could potentially be experiencing transient-spike induced temporary latch-up failures when database 770 stores information that identifies that DC to DC converters can sometimes have temporary failures with characteristics consistent with measurements measured by power monitoring agents before, during, and after a failure has occurred.

In certain instances, transient (temporary) error detection may be accomplished by setting the warning limits for voltage, current, and temperature for all power devices, using the warning limits available. For example the over-voltage and under-voltage warning limits, over temperature warning limits, and over-current warning limits can be set on a power device. The limit values may be determined specifically by manufacturer recommendations, or heuristically by first monitoring the operating voltage, current, and temperature of these devices for a period of time, and determining the mean average and standard deviation ranges. The warning values then may be set to a value within the manufacturer prescribed fault limit, but at one or two standard deviations from the mean. In operation, the power devices which trip the warning limit for voltage, current, or temperature/humidity can be used as early indicators of one-time anomalies. In instances where repeated episodes of warnings occur, then a particular power device may be having difficulty operating within operational limits continuously. In such instances, repeated instances may be a sign that the local power system is having difficulty or that particular types of power devices may be susceptible to temporary fault conditions. A broader examination of like devices in the system and warning limit trip incidents can also indicate a general power system problem replicating itself in a type of power device.

Furthermore, an analysis program may associated a type of device, a manufacturer of a device, date codes associated with a device, or other parameters when identifying failure trends and mapping those trends to possible or probable root causes. As such, the analysis software consistent with the present disclosure may forecast failure types, calculate failure probabilities, and be used to identify precursor events to specific failure types when identifying that a particular device or component may likely fail soon. For example, when probability associated with a type of failure that is associated with a particular device reaches 90%, that particular device could be replaced. Alternatively or additionally, when a failure probability reaches (or approaches) a threshold value, a work load associated with that particular device could be reduced or other operating conditions, such as the temperature or humidity, of the environment where the device resides may be changed with the intent of reducing the probability of that particular device failing.

Similarly, the double arrows illustrated connecting server/server boards 725A/725B of server array 730 to power monitoring agents 740 indicate that power monitoring agents 740 receive data from server array 730 regarding power conditions affecting server/server boards 725A/725B. Power monitoring agents 740 may also collect information relating to DC power inputs 720A/720B. Data collected by power monitoring agents 740 may be sent to power health management receiver 750, where power health management receiver 750 may store that data in database 770 or provide that data to power health management analyzer 760.

Power health management receiver 750 may also generate and output initial activity reports 755. Such reports may be provided to engineers or maintenance staff for review. Initial activity reports 755 may include measurements of raw data collected by power monitoring agents 735/740.

As mentioned above power health management analyzer 760 may receive data directly from power health management receiver 750 or may retrieve data from power health manager database 770. Power health management analyzer 760 may also generate and output extended analysis reports 765. Expended analysis reports 765 may include raw data, may provide information interpreted from collected data over time, and may identify trends in the collected data. As such, systems and method consistent with the present disclosure may provide increasing amounts of and ultimately comprehensive power monitoring, power control, power failure forecasting, power event alerts, power data collection, and that manages power corrective actions. Such systems may also gather intelligence by analyzing data trends over time such that design weaknesses can be identified an addressed in next generation data center computing and power distribution system designs.

In a first example, AC power input data may be compared to DC power output power data when calculating the efficiencies of power supplies 715A/715B over time. Power efficiency versus total load provided by one or more individual power supplies may also be monitored. In instances where the efficiency of one or more power supplies is identified as not meeting a power efficiency threshold, one or more power supplies may be turned off or turned on such that the efficiency of sets of particular power supplies may be maintained above a threshold level.

The power supply efficiency of an AC to DC power supply may be calculated by the equation: efficiency=[(output power/(input power)*power factor]. AC monitoring devices in a data center may include reading a measure of power factor and other statistics when the efficiency of power supplies is being monitored.

In instances when highly efficient power supplies are running well below their maximum power delivery ratings, the efficiency may drop significantly. This efficiency can be calculated using the most recent polling data and a system “map” of the power efficiency can be created or updated. As such, power efficiency data can be used to move programming task workloads around, from one server to another, for example. In other instances programming task workloads may be concentrated on servers or specific groups of racks of servers. Adjusting programming task workloads may cause a workload associated with particular server or groups of servers to drop to zero, idling the server/server group. In instances when programming task workloads associated with a server/server group drops to zero, that server/server group may be powered down to save power.

For example, some AC to DC power supplies are associated with efficiencies as high as 98% when they provide power near their absolute maximum power delivery ratings. These same power supplies, however, may only operate at efficiencies of 60% when providing power of about ½ of their absolute maximum power delivery ratings. When such supplies are identified as operating with about 60% efficiency, one or more power supplies of a set of power supplies may be turned off, causing the remaining power supplies to provide more power at a higher efficiency. As such, analysis program executing on processors may be used to adjust system load factors or workloads by cross referencing current conditions with known efficiencies when adjusting system load factors or workloads.

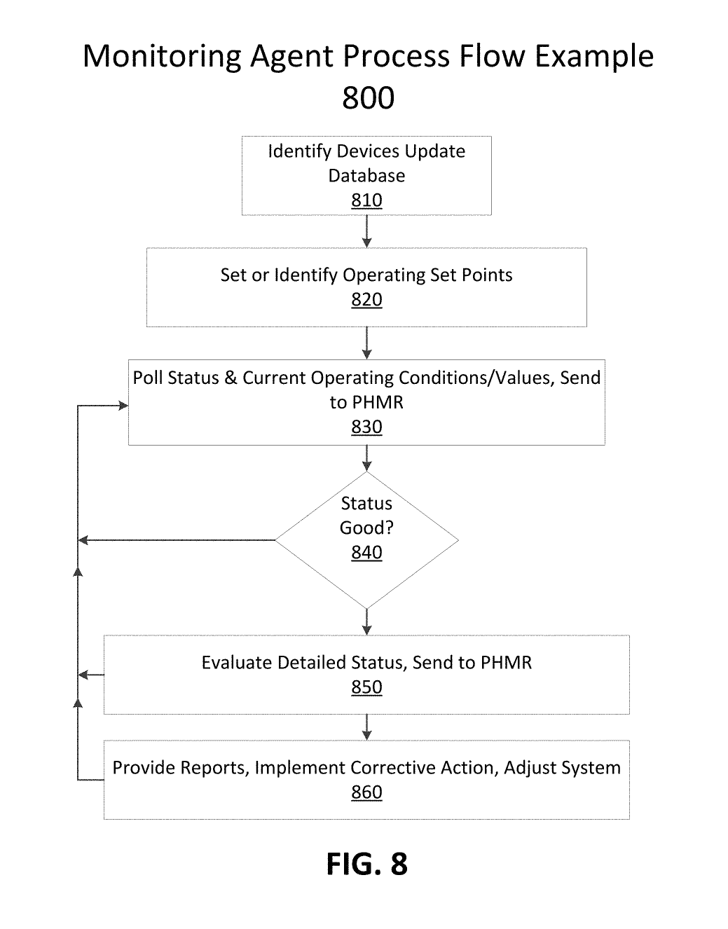

FIG. 8 illustrates an exemplary process flow example that may be implemented by a monitoring agent. The monitoring agent process flow example of FIG. 8 begins with step 810 where power devices are identified and where information relating to the identified power devices may be stored in a database. Identified power devices may include AC to DC power supplies, DC to DC power supplies, monitoring equipment/sensors/circuits, and server array components.

Step 820 of FIG. 8 is a step where the operating set point of the identified power devices may be set or identified. For example, an output voltage of an AC to DC or of a DC to DC power supply may be checked by sending a command to the power supply. In an instance where a specific power supply is programmable, that power supplies programmed output value may be checked (verified). In another example, a set value for a current limit value of a particular power supply may be checked (verified). Step 820 of FIG. 8 may also set programmed output voltages, may set an output current limit value, or may disable a power supply entirely.

Step 830 of FIG. 8 is a step where a current status of or current operating conditions/values of power supplies may be checked (i.e. polled in a round robin or sequential fashion). After the status and operating conditions of particular power devices have been polled, information gathered from each of the power devices polled may be sent to a power health monitoring receiver (PMHR). This information may also be stored in a database.

Next, in step 840, the PMHR may analyze the collected information and identify whether one or more power devices are operating with a good status (i.e. operating within operating parameters without crossing or approaching a threshold value). In the instance when the power devices are operating with a good status, program flow may move back to step 830 where the status of the power devices is polled again. Alternatively or additionally a power health management analyzer in communication (760 of FIG. 7) with the PMHR may identify the status of power devices in the data center.

In the instance where a power device is not operating within operational parameters, program flow may move to step 850, where a detailed status of power devices that are not operating with operational parameters may be evaluated with more detail. Then in step 860, reports relating to the power devices not operating within expected operational operating parameters may be provided to management or service personnel. Alternatively or additionally, corrective actions or system adjustments may be made to bring the system back within expected operating parameters. Here again a PMHR and/or a power health management analyzer may perform analysis. As such, the functions of steps 840, 850, and 860 may be performed by a plurality of discrete software programs or could be performed by a single monolithic software program.

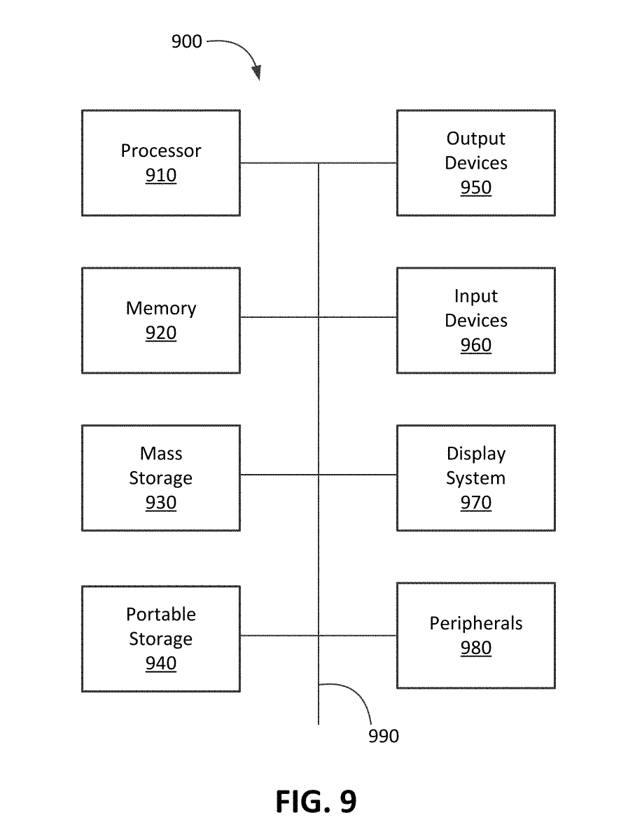

FIG. 9 is a block diagram of an exemplary system for implementing a computing device. The computing system 900 of FIG. 9 includes one or more processors 910 and memory 920. Main memory 910 stores, in part, instructions and data for execution by processor 910. Main memory 920 can store the executable code when in operation. The system 900 of FIG. 9 further includes a mass storage device 930, portable storage medium drive(s) 940, output devices 950, user input devices 960, a graphics display 970, and peripheral devices 980.

The components shown in FIG. 9 are depicted as being connected via a single bus 990. However, the components may be connected through one or more data transport means. For example, processor unit 910 and main memory 920 may be connected via a local microprocessor bus, and the mass storage device 930, peripheral device(s) 980, portable storage device 940, and display system 970 may be connected via one or more input/output (I/O) buses.

Mass storage device 930, which may be implemented with a magnetic disk drive or an optical disk drive, is a non-volatile storage device for storing data and instructions for use by processor unit 910. Mass storage device 930 can store the system software for implementing embodiments of the present invention for purposes of loading that software into main memory 920.

Portable storage device 940 operates in conjunction with a portable nonvolatile storage medium, such as a floppy disk, compact disk or Digital video disc, to input and output data and code to and from the computer system 900 of FIG. 9. The system software for implementing embodiments of the present invention may be stored on such a portable medium and input to the computer system 900 via the portable storage device 940.

Input devices 960 provide a portion of a user interface. Input devices 960 may include an alpha-numeric keypad, such as a keyboard, for inputting alpha-numeric and other information, or a pointing device, such as a mouse, a trackball, stylus, or cursor direction keys. Additionally, the system 900 as shown in FIG. 9 includes output devices 950. Examples of suitable output devices include speakers, printers, network interfaces, and monitors.

Display system 970 may include a liquid crystal display (LCD) or other suitable display device. Display system 970 receives textual and graphical information, and processes the information for output to the display device.

Peripherals 980 may include any type of computer support device to add additional functionality to the computer system. For example, peripheral device(s) 980 may include a modem or a router.

The components contained in the computer system 900 of FIG. 9 are those typically found in computer systems that may be suitable for use with embodiments of the present invention and are intended to represent a broad category of such computer components that are well known in the art. Thus, the computer system 900 of FIG. 9 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, iOS, Android and other suitable operating systems.

Table 1 illustrates exemplary device “key” information that may be collected from a power device according to the PMBUS specification. Note that key information included in table 1 includes a manufacture identifier (MRF_ID), a model (MFR_MODEL), a revision number (MFR_REVISION), a location where the device was manufactured (MFR_LOCATION), a data of manufacture (MFR_DATE), and serial number (MFR_SERIAL). A power monitoring device of the present disclosure may collect this key information when power devices are identified as being part of an inventory of power devices in step 810 of FIG. 8. By reading these values sub-management controller 450 may collect information relating to a manufacturer identifying code, a model number or indicator, revision number or label, a serial number, a date of manufacture, and a place of manufacture. This information collected may be stored in a database for reference by a software program or by examination by personnel working in a data center.

TABLE 1
Power Device Key Information

| | | SMBus | SMBus | |
|---|---|---|---|---|
| | | Transaction | Transaction | |
| | | Type: | Type: | Number |
| Command | Command | Writing | Reading | Of Data |
| Code | Name | Data | Data | Bytes |
| 99h | MFR_ID | Block Write | Block Read | Variable |
| 9Ah | MFR_MODEL | Block Write | Block Read | Variable |
| 9Bh | MFR_REVISION | Block Write | Block Read | Variable |
| 9Ch | MFR_LOCATION | Block Write | Block Read | Variable |
| 9Dh | MFR_GATE | Block Write | Block Read | Variable |
| 9Eh | MFR_SERIAL | Block Write | Block Read | Variable |

Table 2 illustrates exemplary commands consistent with the PMBUS standard. The commands in table 2 may be used to identify the status of output voltages (STATUS_VOUT), the status of output current (STATUS_TOUT), the status of an input (STATUS_INPUT), a temperature status (STATUS_TEMPERATURE), and the status of other features or functions associated with a power device.

TABLE 2
Power Device Status Commands

| | | SMBus | SMBus | |
|---|---|---|---|---|
| | | Transaction | Transaction | |
| | | Type: | Type: | Number |
| Command | Command | Writing | Reading | Of Data |
| Code | Name | Data | Data | Bytes |
| 78h | STATUS_BYTE | Write Byte | Read Byte | 1 |
| 79h | STATUS_WORD | Write Word | Read Word | 2 |
| 7Ah | STATUS_VOUT | Write Byte | Read Byte | 1 |
| 7Bh | STATUS_IOUT | Write Byte | Read Byte | 1 |
| 7Ch | STATUS_INPUT | Write Byte | Read Byte | 1 |
| 7Dh | STATUS_TEMPERATURE | Write Byte | Read Byte | 1 |
| 7Eh | STATUS_CML | Write Byte | Read Byte | 1 |
| 7Fh | STATUS_OTHER | Write Byte | Read Byte | 1 |
| 80h | STATUS_MFR_SPECIFIC | Write Byte | Read Byte | 1 |
| 81h | STATUS_FANS_1_2 | Write Byte | Read Byte | 1 |
| 82h | STATUS_FANS_3_4 | Write Byte | Read Byte | 1 |
| 86h | READ_EIN | N/A | Block Read | 5 |
| 87h | READ_EOUT | N/A | Block Read | 5 |
| 88h | READ_VIN | N/A | Read Word | 2 |
| 89h | READ_IIN | N/A | Read Word | 2 |
| 8Ah | READ_VCAP | N/A | Read Word | 2 |
| 8Bh | READ_VOUT | N/A | Read Word | 2 |
| 8Ch | READ_IOUT | N/A | Read Word | 2 |
| 8Dh | READ_TEMPERATURE_1 | N/A | Read Word | 2 |
| 8Eh | READ_TEMPERATURE_2 | N/A | Read Word | 2 |
| 8Fh | READ_TEMPERATURE_3 | N/A | Read Word | 2 |
| 90h | READ_FAN_SPEED_1 | N/A | Read Word | 2 |
| 91h | READ_FAN_SPEED_2 | N/A | Read Word | 2 |
| 92h | READ_FAN_SPEED_3 | N/A | Read Word | 2 |
| 93h | READ_FAN_SPEED_4 | N/A | Read Word | 2 |
| 40h | VOUT_OV_FAULT_LIMIT | Write Word | Read Word | 2 |
| 41h | VOUT_OV_FAULT_RESPONSE | Write Byte | Read Byte | 1 |
| 42h | VOUT_OV_WARN_LIMIT | Write Word | Read Word | 2 |
| 43h | VOUT_UV_WARN_LIMIT | Write Word | Read Word | 2 |
| 44h | VOUT_UV_FAULT_LIMIT | Write Word | Read Word | 2 |
| 45h | VOUT_UV_FAULT_RESPONSE | Write Byte | Read Byte | 1 |

As described above in respect to FIG. 8, monitoring agents periodically poll the status of a power device. This may include polling a “STATUS_WORD” value. In the PMBUS standard, status is hierarchical: this means that when a “STATUS_BYTE” read indicates that a power device has a problem, a monitoring agent can then provide one or more additional reads of the “STATUS_WORD” after which one or more other “STATUS” registers may be read, as desired. The commands of table 2 may also be used to collect operating values for voltage, current, power, and temperature. The status of fans associated with a power device can also be monitored with these commands as well. As mentioned in respect to FIG. 8, each of the values collected by a power device may also be polled periodically and saved in a power management database.

In regard to operating warnings and faults, there are numerous PMBUS specification registers that may be read when gathering information relating to various faults. Note that Table 2 includes registers that identify output over voltage faults (such as VOUT_OV_FAULT_LIMIT), over/under voltage warning and fault limit conditions (such as VOUT_OV_WARN_LIMIT), and over/under voltage fault response indications (such as VOUT_UV_FAULT_RESPONSE).

Standards like the PMBUS may include other similar commands/status registers that may be used when setting warnings and faults relating to input voltage, input current, output current, temperature, and/or humidity.

Analysis programs consistent with the present disclosure may also identify or be used to identify weaknesses in the design of the data center. For example, temperature sensor data may be used to identify locations within servers that have high temperatures in a particular region within a server cabinet. This high temperature data may also be combined with failure information collected over time. When a high failure rate of components or devices that reside within that particular region of the server cabinet are identified, the failure data may be cross referenced with the temperature data when identifying that a next generation server design should include improved cooling, that the susceptible components/devices be replaced with more robust components/devices in a next revision of the server, or that the susceptible components/devices should be replaced with compatible components/devices that consume less power in the next generation server design.

Additionally modern computing systems may slow down the processing speed of a plurality of processors when temperatures associated with a single processor has reached threshold level. This may occur even when the processor is operating within a normal operating temperature range. In such instances, the processor may initiate their own speed reduction in an attempt to prevent the temperature of the processor from reaching a point of concern. One reason why this speed reduction may reduce the execution speed of a plurality of processors is because highly parallel computing applications (such as simulations) often require many processors to run in a lock-step fashion. As such, in highly parallel applications, other processors may have to wait for a “slowed down” processor when calculations performed by those other processors require results of operations performed at the “slowed down” processor. Thus, as processing speed of one processor slows, so can the processing speed of many other processors. When one or more processors slow down, the entire application will slow down. By tracking the status of power devices and by reviewing thermal maps, environmental factors, such as high processors temperatures may be addressed before the processing speed of a processor slows down.

Analysis programs of the present disclosure may also combine multiple types of sensor data when identifying design weaknesses. For example, both temperature and humidity may be associated with a failure rate and the design of the data center may be updated to mitigate worst case combined temperature and humidity conditions.

As such, an important goal of analysis programs executing in the data center is to associate failure history with data collected over time when forecasting failures based on probabilities calculated from the failure history and the collected data. Data collected may include any combination of environmental sensed data; may include measurements of voltage, current, or power; and may include status data collected from power devices over time. Status data may include measures of efficiency, such as the efficiency of particular power supplies over time. Increasing the accuracy of failure forecasting and failure prevention over time are important goals of systems and methods consistent with the present disclosure.

Mappings that identify an absolute or relative connection topology of power devices and servers or server boards of the present disclosure may be stored in the database. Such mappings may have been created by various means. In certain instances identification of device locations is a combination of available information and hand editing where gaps occur. In the present computing systems of the present disclosure, much of the infrastructure may be accessible across an Ethernet network. Various management controllers and PDUs may be assigned IP hostnames at system installation time. These hostnames may be associated with a physical absolute or with a relative location. For example, a rack management controller itself may be named a combination of a rack number and rack position and controller type. Therefore the rack controller in rack 5, position 6 may be named r05i06rmc., where the ‘rmc’ suffix indicates a controller. For a server board with a baseboard management controller (BMC) a hostname example is r03i17bmc. The secondary identification of the various power devices that any given management controller is operating may also have a designated name to associate to the devices that is location oriented. A bank of power supplies in a rack all reside at labeled or mapped locations, where each labeled location may correspond to a PMBUS address to be used by particular power devices. A management controller may be pre-programmed to translate a PMBUS address to a labeled location. In this manner any particular power device has its information reported by a unique geographic location name, such as r005i06rmc-ps04. Due to the practice of geographic location names, developing any particular physical map of device statistics or warning and fault events is now easily sorted into racks, position within racks, and position of the actual device on a board or a tray of devices. Various reports generated using geolocation orientation can show trends for power efficiency, Temperature-to-power correlation, faults, and so on.

In other instances, as power is initially applied to a server in a data center, power monitoring agents may provide information that is included in a mapping. For example, a power monitoring agent may identify that the power (or current) provided by particular power supplies is co-incident with the starting of a server. In such instances, the event of starting a server may be identified by an operator that powers the server on, this may be accomplished by the operator entering information into a user interface. Such a user interface may be provided to the operator via a mobile device or via an administration console connected to a network connection. For example, the user interface may be provided on a display system of the computing system of FIG. 9.

Data centers of the present disclosure may include power devices capable of appending a signal to incoming power phases, where each phase carries a unique signal that identifies the incoming power phase. Methods for embedding data signals on power lines are known to use frequencies that are either higher or lower than the frequency of the AC power provided to the data center. As such, AC power monitoring devices that monitor AC power inputs to certain servers (or server groups) could identify the power phase currently powering the server or server groups. When AC power switches in the data center have a known (absolute or relative) location, the absolute or relative location of particular servers/server group could be identified by switching power provided to a particular server/server group and by power devices sending power phase signal data to a power monitoring agent.

Additionally or alternatively, the power monitoring agents in a data center may each be associated with an absolute or a relative location. As computing equipment is added to the data center, a mapping of the topology of the data center may be updated based on data received by the power monitoring agents. In instances where servers include power monitoring agents with pre-defined topologies, mappings of power devices in the data center may be updated based on those pre-defined topologies.

As such, mappings that cross reference the (absolute or relative) locations of power devices with specific pieces of equipment in the data center may be created by manual means, by automatic means, or by a combination of manual and automatic means.

The comprehensive monitoring of power in the data center may include any of the techniques described in this disclosure, where data stored in a power health monitoring database may include information relating to mappings of power devices/computer connections, power supply reference numbers, power device types, power supply serial numbers, AC power input levels, AC power input voltage levels, measures/values of AC input current, measures/values of DC power output, measures/values of DC voltage output, measures/values of power efficiency, measures/values of DC output current, temperatures, humidity, combinations of temperatures/humidity indicative of condensation (rain in a chamber), known or suspected fault modes, the presence of smoke or excessive carbon dioxide, and other operating characteristics.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A method for monitoring devices in a data center, the method comprising:
receiving information relating to a plurality of power devices in a data center;
storing the received information relating to the plurality of power devices in a database;
collecting information from each respective power device of the plurality of power devices over a first time period, wherein the information collected from each of the respective power devices of the plurality of power devices corresponds to an operating condition at each of the respective power devices over the first time period;
storing the information collected from each respective power device over the first time period in the database;
identifying that a status associated with a first power device of the plurality of power devices is not good based on a current operating condition of the first power device; and
sending a message indicating that the status of the first power device is not good, wherein corrective action is taken based on the message sent indicating that the status of the first power device is not good.

2. The method of claim 1, wherein:
at least a portion of the information stored in the database over the first period of time is provided to a processor executing instructions out of a memory,
the information collected includes a plurality of sets of information relating to the first power device and to a plurality of data sets of one or more other power devices associated with the first power device,
the association of the first power device and one or more other power devices corresponds to a mapping of the first power device and the one or more other power devices,
one or more candidate failure precursor operating conditions based on the plurality of sets of information relating to the first power device and to the plurality of data sets of the one or more other power devices associated with the first power device are identified,
a report that identifies the one or more failure precursor operating conditions is generated, and
the report is transmitted over a network interface.

3. The method of claim 1, wherein information corresponding to a location of one or more power devices of the plurality of power devices is included in a map of the data center.

4. The method of claim 1, wherein the plurality of power devices include at least one of an alternating current (AC) power monitor, and AC to direct current (DC) power supply, a DC to DC power supply, and a sensor.

5. The method of claim 4, wherein the sensor includes at least one of a temperature sensor or a humidity sensor.

6. The method of claim 1, wherein the message indicating that the status of the first power device is not good corresponds to a measure of temperature and a measure of humidity.

7. The method of claim 6, wherein the corrective action includes an action that reduces at least one of the measure of temperature or the measure of humidity.

8. A non-transitory computer readable storage medium having embodied thereon a program executable by a processor for a method of monitoring devices in a data center, the method comprising:
receiving information relating to a plurality of power devices in a data center;
storing the received information relating to the plurality of power devices in a database;
collecting information from each respective power device of the plurality of power devices over a first time period, wherein the information collected from each of the respective power devices of the plurality of power devices corresponds to an operating condition at each of the respective power devices over the first time period;
storing the information collected from each respective power device over the first time period in the database;
identifying that a status associated with a first power device of the plurality of power devices is not good based on a current operating condition of the first power device; and
sending a message indicating that the status of the first power device is not good, wherein corrective action is taken based on the message sent indicating that the status of the first power device is not good.

9. The non-transitory computer readable storage medium of claim 8, wherein:
at least a portion of the information stored in the database over the first period of time is provided to a processor executing instructions out of a memory,
the information collected includes a plurality of sets of information relating to the first power device and to a plurality of data sets of one or more other power devices associated with the first power device,
the association of the first power device and one or more other power devices corresponds to a mapping of the first power device and the one or more other power devices,
one or more candidate failure precursor operating conditions based on the plurality of sets of information relating to the first power device and to the plurality of data sets of the one or more other power devices associated with the first power device are identified,
a report that identifies the one or more failure precursor operating conditions is generated, and
the report is transmitted over a network interface.

10. The non-transitory computer readable storage medium of claim 9 wherein information corresponding to a location of one or more power devices of the plurality of power devices is included in a map of the data center.

11. The non-transitory computer readable storage medium of claim 10, wherein the plurality of power devices include at least one of an alternating current (AC) power monitor, and AC to direct current (DC) power supply, a DC to DC power supply, and a sensor.

12. The non-transitory computer readable storage medium of claim 11, wherein the sensor includes at least one of a temperature sensor or a humidity sensor.

13. The non-transitory computer readable storage medium of claim 10, wherein the message indicating that the status of the first power device is not good corresponds to a measure of temperature and a measure of humidity.

14. The non-transitory computer readable storage medium of claim 13, wherein the corrective action includes an action that reduces at least one of the measure of temperature or the measure of humidity.

15. A system for monitoring devices in a data center, the system comprising:
a plurality of power devices;
a plurality of computing devices, wherein at least a sub-set of the plurality of power devices provides power to the plurality of power devices and a processor executing instructions out of a memory at a data collection device:
receives information relating to a plurality of power devices in a data center;
stores the received information relating to the plurality of power devices in a database,
collects information from each respective power device of the plurality of power devices over a first time period, wherein the information collected from each of the respective power devices of the plurality of power devices corresponds to an operating condition at each of the respective power devices over the first time period;
stores the information collected from each respective power device over the first time period in the database,
identifies that a status associated with a first power device of the plurality of power devices is not good based on a current operating condition of the first power device, and
sends a message indicating that the status of the first power device is not good, wherein corrective action is taken based on the message sent indicating that the status of the first power device is not good.

16. The method of claim 15, wherein:
at least a portion of the information stored in the database over the first period of time is provided to a processor executing instructions out of a memory,
the information collected includes a plurality of sets of information relating to the first power device and to a plurality of data sets of one or more other power devices associated with the first power device,
the association of the first power device and one or more other power devices corresponds to a mapping of the first power device and the one or more other power devices,
one or more candidate failure precursor operating conditions based on the plurality of sets of information relating to the first power device and to the plurality of data sets of the one or more other power devices associated with the first power device are identified,
a report that identifies the one or more failure precursor operating conditions is generated, and
the report is transmitted over a network interface.

17. The system of claim 15, wherein information corresponding to a location of one or more power devices of the plurality of power devices is included in a map of the data center.

18. The system of claim 15, wherein the plurality of power devices include at least one of an alternating current (AC) power monitor, and AC to direct current (DC) power supply, a DC to DC power supply, and a sensor.

19. The system of claim 18, wherein the sensor includes at least one of a temperature sensor or a humidity sensor.

20. The system of claim 15, wherein the message indicating that the status of the first power device is not good corresponds to a measure of temperature and a measure of humidity, and the corrective action includes an action that reduces at least one of the measure of temperature or the measure of humidity.
